(19) United States
(12) Patent Application Publication
(10) Pub. No.: US 2006/0070468 A1
(43) Pub. Date: Apr. 6, 2006

(54) Motor

(75) Inventor: Shingo Omori, Toyohashi-city (JP)

Correspondence Address: POSZ LAW GROUP, PLC, 12040 SOUTH LAKES DRIVE, SUITE 101, RESTON, VA, 20191, US

(73) Assignee: ASMO CO., LTD.

(21) Appl. No.: 11/229,594

(22) Filed: Sep. 20, 2005

(30) Foreign Application Priority Data
Sep. 28, 2004 (JP) 2004-282499

(51) Int. Cl. H02K 5/16

(52) U.S. Cl. 74/89.14

(57) ABSTRACT

A motor having a motor portion and a speed-reducing portion includes a gear housing disposed on the motor portion, a bearing press-fitted in the gear housing, a worm shaft rotatably held in the bearing, a worm wheel rotatably held in the gear housing with engagement to the worm shaft. The gear housing has a bearing hole for accommodating the bearing. An inner circumference of the bearing hole includes a contact portion for press-fittingly holding the bearing. A circumferential dimension of the contact portion is different at a different circumferential position, and at least one contact portion is positioned in an opposite side to a worm wheel engagement side of the worm shaft.

### CROSS REFERENCE TO RELATED APPLICATION

This application is based on and claims the benefit of priority of Japanese Patent Application No. 2004-282499 filed on Sep. 28, 2004, the disclosure of which is incorporated herein by reference.

### FIELD OF THE INVENTION

The present invention generally relates to a motor device for actuating an automotive apparatus.

### BACKGROUND OF THE INVENTION

Conventionally, a motor used for a power window system or the like includes a motor portion having a rotation shaft and a speed-reducing portion connected to the motor portion. The speed-reducing portion includes a gear housing, a worm shaft, and a worm wheel for decelerating rotation of the rotation shaft. The speed-reducing portion may include a press-fitted bearing in a bearing hole of the gear housing. The press-fitted bearing rotatably holds the worm shaft.

The bearing hole in a motor without having the speed-reducing portion has contact portions toward the bearing on an inner circumference of the bearing hole formed at an equiangular distance for press-holding the bearing (refer to Japanese Patent Document JP-U-H6-44364). In this scheme of structure, the bearing is held by a plurality of small contact portions positioned equidistantly on an inner circumference of the bearing hole, thereby enabling appropriate assembly of the press-fitted bearing in the bearing hole even when dimensional accuracy of the assembly is moderate.

However, this scheme of structure described above causes a problem when it is applied in the motor having a speed-reducing portion. That is, a reaction force from the worm shaft being engaged with the worm wheel to the press-fitted bearing concentrates on the small contact portions between the press-fitted bearing and the bearing hole on the other side of the worm shaft relative to the worm wheel. Therefore, the concentrated reaction force causes, for example, breakage and/or deformation of the bearing/bearing hole. The concentrated reaction force may cause a squeaky sound when an oil film normally formed on a sliding surface between an oil-impregnated bearing and the worm shaft is broken.

### SUMMARY OF THE INVENTION

In view of the above-described and other problems, it is an object of the present invention to provide a motor that has a speed-reducing portion being protected from the concentration of a mechanical force on a small portion without having a high accuracy of structure for press-fitting of a bearing.

The motor in an embodiment of the present invention includes a motor portion and a speed-reducing portion connected thereto. The speed-reducing portion has a gear housing fixed on the motor portion, a bearing fixed on the gear housing, a worm shaft being rotatably held by the bearing, a worm wheel being rotatably held by the bearing having engagement to the worm shaft. The gear housing has a bearing hole for accommodating the bearing press-fittingly held therein. An inner circumference of the bearing hole has a small contact portion that holds the bearing at a small circumferentially extending portion (small contact portion) and a large contact portion that holds the bearing by an area that is circumferentially larger than the small contact portion. The large contact portion is formed axially on an opposite side to the worm wheel engagement side of the worm shaft. In this manner, dimension of the bearing hole does not have to be highly accurate for appropriate assembly. Further, breakage, deformation, and/or a squeaky operation sound from the bearing/bearing hole are prevented because a reaction force from the worm shaft and/or the worm wheel is evenly borne by the large contact portion of the bearings without concentration to a small area in the bearing.

According to one aspect of the present invention, the bearing used in the motor is an oil-impregnated bearing. That is, the oil-impregnated bearing forms an oil film on its surface. The oil film formed on the surface is maintained when the pressure between the bearing and the worm shaft is evenly distributed. In an embodiment of the present invention, the large contact portion better serves for evenly distributing the pressure than the small contact portions that is conventionally used to press-fittingly hold the bearing, because no gap is formed between the bearing and the bearing hole when the large contact portion is used. Therefore, the squeaky operation sound is prevented by the oil film formed between the bearing and the worm shaft.

According to another aspect of the present invention, the small contact portion is formed at plural positions along an inner circumference of the bearing hole in the gear housing. In this manner, the bearing is held securely and evenly from all directions.

According to yet another aspect of the present invention, the large contact portion extends substantially over a center angle of 180 degrees in a circumferential direction for holding the bearing.

According to still another aspect of the present invention, the small contact portion has following characteristics. That is, the small contact portion may have a surface that is a tangent plane of a circle that is diametrically smaller than an outer circumference of the bearing. The small contact portions may also be positioned equidistantly on the circumference of the bearing. The small contact portion may also be positioned equiangularly substantially at every 45 degrees along the circumference of the bearing.

According to further aspects of the present invention, a pair of the bearings are disposed at both ends of the worm shaft. Both ends of the worm shaft are held by the pair of bearings.

According to yet still another aspect of the present invention, the small contact portion and the large contact portion may be disposed on an outer circumference of the bearing that is press-fitted in the bearing hole.

### BRIEF DESCRIPTION OF THE DRAWINGS

Other objects, features and advantages of the present invention will become more apparent from the following detailed description made with reference to the accompanying drawings, in which:

FIG. 1 is a cross-sectional view of a motor in an embodiment of the present invention;

FIG. 2 is a portion of the cross-sectional view of the motor in the embodiment;

FIG. 3 is an illustration of a gear housing in the embodiment;

FIG. 4 is an illustration of a bearing hole in the embodiment;

FIG. 5 is a cross-sectional view of the bearing hole in another embodiment; and

FIG. 6 is a cross-sectional view of the bearing hole in yet another embodiment.

### DETAILED DESCRIPTION OF THE PREFERRED EMBODIMENTS

A motor of the present invention is described with reference to the drawings.

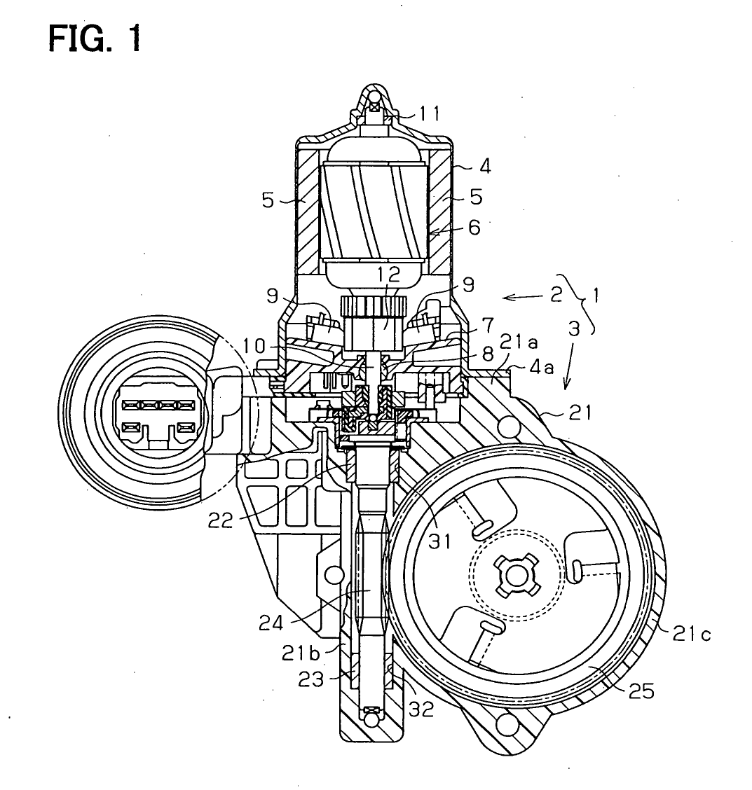

FIG. 1 shows a cross-sectional view of a motor 1 in an embodiment of the present invention. The motor 1 includes a motor portion 2 and a speed-reducing portion 3.

The motor portion 2 has a yoke housing (referred to as a yoke hereinafter) 4 that is generally formed in a flat cylinder shape with a bottom, a pair of magnets 5 fixed on an inner surface of the yoke 4, an armature 6 rotatably held in the yoke 4, and a brush holder 7.

The brush holder 7 is made of a resin, and is disposed on an opening of the yoke 4. The brush holder 7 holds a bearing 8 and a brush 9. A rotation shaft 10 of the armature 6 is rotatably held by the bearing 8 and a bearing 11 that is fixed at a bottom of the yoke 4. The brush 9 is press-contacted against a rectifier 12 of the armature 6.

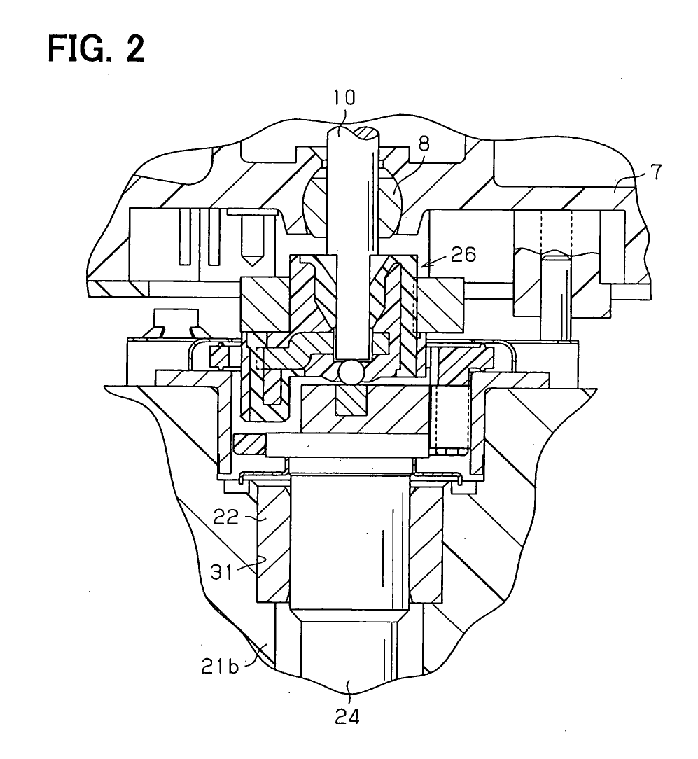

The speed-reducing portion 3 includes a gear housing 21, a pair of bearings 22, 23, a worm shaft 24, a worm wheel 25, and a clutch 26. The speed-reducing portion 3 is shown in FIG. 2. The gear housing 21 is made of a resin. The gear housing 21 has a fixed portion 21a, a worm housing 21b, and a wheel housing 21c.

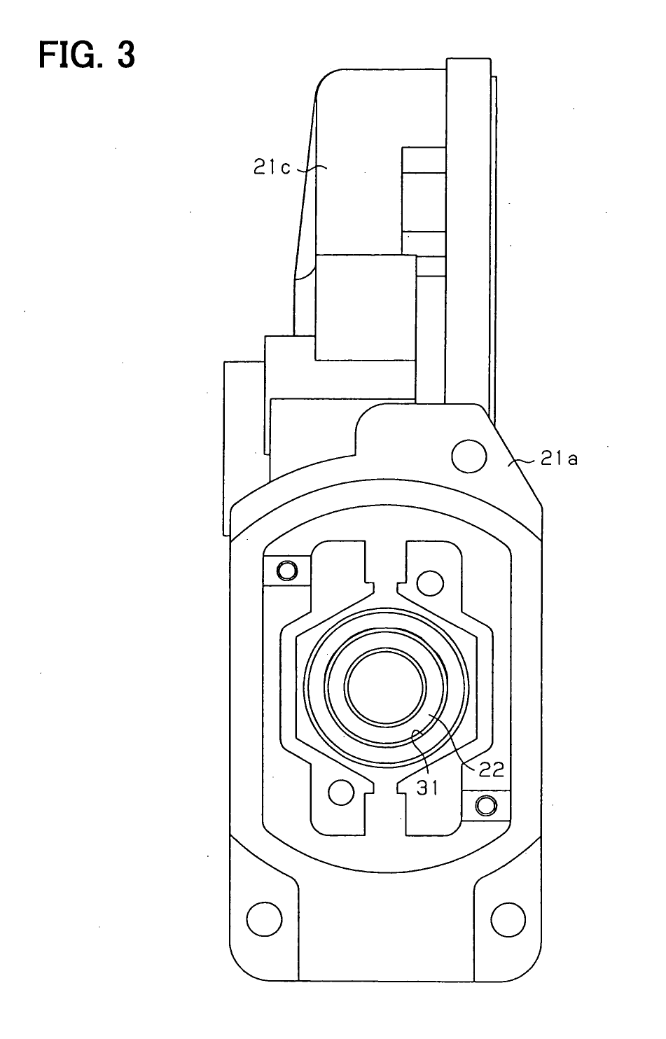

The fixed portion 21a is formed in a shape that is fitted to a flange 4a at the opening of the yoke 4. The fixed portion 21a is shown in FIG. 3. The fixed portion 21a is fixed by a screw on the flange 4a. The brush holder 7 is held between the fixed portion 21a and the flange 4a. The fixed portion 21a in FIG. 3 is the gear housing 21 shown in an axial direction of the rotation shaft 10. The fixed portion 21a shown in FIG. 3 is in a form without the worm shaft 24 and the clutch 26 being fitted therein.

The worm housing 21b is formed in a cylindrical shape extending on an extension of the rotation shaft 10, and rotatably holds the worm shaft 24 in its body by using the bearings 22, 23. The worm housing 21b has the clutch 26 on a motor 2 side for connectably driving the worm shaft 24 and the rotation shaft 10. The clutch 26 transfers a driving force from the rotation shaft 10 to the worm shaft 24, and prevents backlash of the driving force from being transferred from the worm shaft 24 toward the rotation shaft 10 by locking the rotation of the worm shaft 24. That is, the clutch 26 prevents the motor 1 from being driven by a force from a driven mechanism.

The wheel housing 21c is formed in a flat disk shape, and is disposed perpendicularly to the worm housing 21b. The wheel housing 21c rotatably holds a worm wheel 25 in its body. An inside space of the worm housing 21b and an inside space of the wheel housing 21c communicate with each other at a connecting portion, and the worm shaft 24 is engaged with the worm wheel 25 at the connecting portion. An output axis (not shown in the figure) is engaged with the worm wheel 25 to actuate a window through a regulator or the like (not shown in the figure).

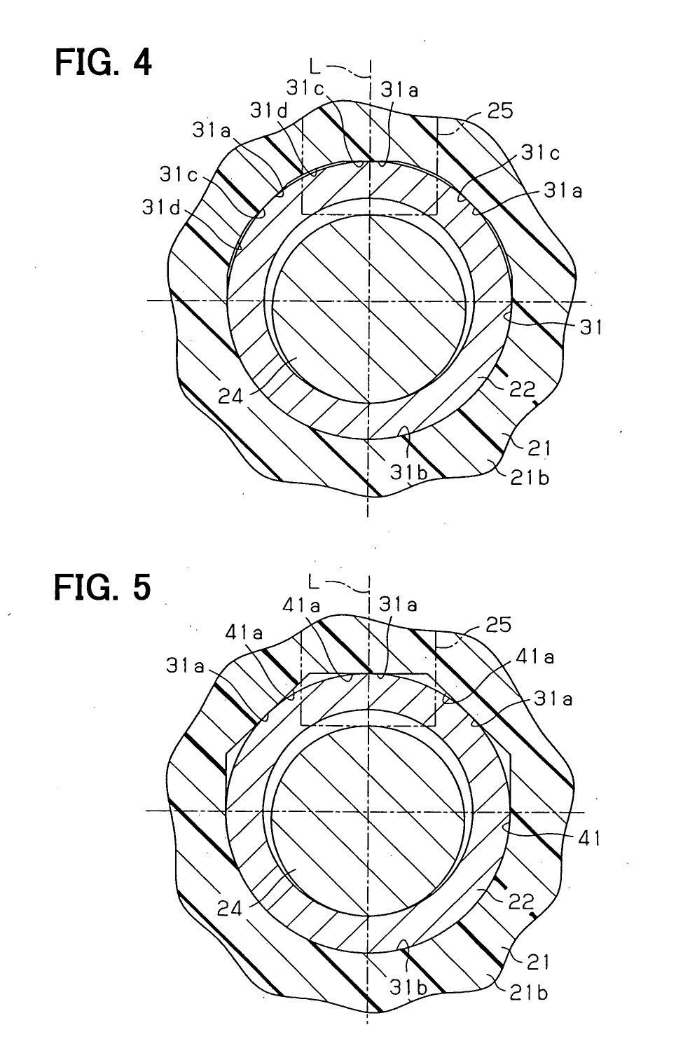

The bearings 22 and 23 are fixed in the bearing holes 31 and 32 formed in the gear housing 21 (worm housing 21b). Specifically, the bearings 22 and 23 are oil-impregnated bearings, and have a cylindrical shape for both of inner/outer circumferential surfaces. The gear housing 21 has the bearing hole 31 on a motor 2 side in the worm housing 21b as shown in FIGS. 2 to 4. The bearing hole 31 has a small contact portion 31a and a large contact portion 31b formed on its inner circumference as shown in FIG. 4. The small contact portion 31a and the large contact portion 31b hold the bearing 22 by its outer circumference. The area of contact of the large contact portion 31b is larger than that of the small contact portion 31a in terms of the length in a circumferential direction of the bearing 22. The large contact portion 31b holds an opposite side of the worm shaft 24 relative to a worm wheel 25 engagement side (lower side in FIG. 4). The large contact portion 31b covers half of the outer circumference of the bearing 22, that is, the large contact portion 31b substantially has a center angle of 180 degrees. In addition, the small contact portion 31a is formed at plural positions along the inner circumference of the bearing hole 31. The number of the small contact portions 31a is three in this embodiment. The small contact portions 31a are formed symmetrically relative to a center line L at an angular interval of 45 degrees. The small contact portions 31a are formed on the worm wheel 25 engagement side of the worn shaft 24, and the large contact portion 31b is formed on the opposite side of the small contact portions 31a on the worm shaft 24. More specifically, the small contact portions 31a are formed as tangent planes 31c of a circle that has a slightly smaller radius than the outer circumference of the bearing 22. The tangent planes 31c as small contact portions 31a are formed on an inner circumference 31d of the bearing hole 31 that has a slightly larger radius than the outer circumference of the bearing 22.

The worm shaft 24 is drawn smaller than an actual proportion to the bearing 22 for illustration purpose in FIG. 4. The bearing 23 and the bearing hole 32 are not shown in the figure because they are functionally identical to the bearing 22 and the bearing hole 31 only with the difference of dimensions. That is, the bearing hole 32 has the small and large contact portions.

The small contact portions 31 a disposed on the inner surface of the bearing hole 31 creates gaps between the bearings 22, 23 and the bearing hole 31. These gaps prevents the pressure between the worm shaft 24 and the bearings 22, 23 to be evenly distributed in a circumferential direction of the bearings 22, 23. That is, an oil film formed on the surface of an oil-impregnated bearings 22, 23 may be broken when the distribution of the pressure is uneven. However, the bearing hole 31 holds the bearings 22, 23 by the large contact portion 31b in the present invention, thereby enabling the oil film suitably maintained on the surface of the bearings 22, 23. Therefore, the squeaky operation sound, for example, is prevented. Further, leakage of oil that forms the oil film on the surface of the bearings 22, 23 is prevented by the large contact portion 31b. Therefore, an outer circumferential surface of the oil impregnated bearings 22, 23 does not have to be processed to have a precise size for press-fitting.

Although the present invention has been fully described in connection with the preferred embodiment thereof with reference to the accompanying drawings, it is to be noted that various changes and modifications will become apparent to those skilled in the art.

The bearing holes 31 and 32 have the small contact portions 31a and the large contact portion 31b on its inner circumference in the embodiment described above. However, the small contact portions 31a and the large contact portion 31b may be formed differently as long as the large contact portion 31b holds the opposite side of the worm shaft 24 relative to the worm wheel 25 engagement side.

For example, the bearing hole 31 may be formed in a shape of a bearing hole 41 as shown in FIG. 5. In this case, planes 41a as the small contact portions are connected each other to form a octagon.

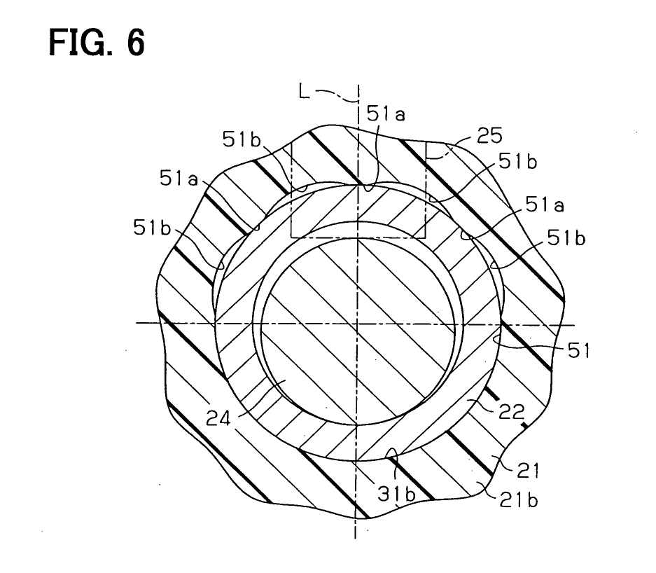

Further, the bearing hole 31 may be formed in a shape of a bearing hole 51 as shown in FIG. 6. In this case, planes 51a as the small contact portions are formed as convex portions between two arc shape concave portions on an inner circumference that has a slightly smaller radius than the outer circumference of the bearing 22.

Furthermore, the number of small contact portions 31a may be more than three, or may be less than three.

Furthermore, the large contact portion 31b may have a different center angle from the one in the above-described embodiment. That is, the center angle of the large contact portion 31b may be 90 degrees, or 120 degrees as far as the large contact portion 31b is formed on the opposite side of the worm shaft 24 relative to the worm wheel 25 engagement side of the worm shaft 24.

Furthermore, the small contact portions 31a and the large contact portion 31b may only be formed on one of the pair of bearings 22 and 23.

Furthermore, the oil-impregnated bearings 22, 23 may be other types of bearings. For example, ball bearings may be used to have a same functional effect, that is, prevention of the breakage, deformation, and/or a squeaky operation sound.

Furthermore, the clutch 26 may be omitted in a connecting portion between the rotation shaft 10 and the worm shaft 24. That is, the rotation shaft 10 and the worm shaft 24 may be connected by a joint or the like.

The inner circumference of the bearing holes 31, 32 may not necessarily be in a round shape. That is, the inner circumference of the bearing holes 31, 32 may be a tangent plane of a certain circle to be press-fitted to the bearing 22, 23 as shown in the embodiment in FIG. 5.

The motor 1 in the embodiment is used to actuate a power window system. However, the motor of the present invention may be used to actuate and operate other type of apparatus. For example, the motor 1 may be used to operate a sun roof, a wiper or the like. The motor 1 may be used in an automobile, or may be used in other type of vehicle.

Such changes and modifications are to be understood as being within the scope of the present invention as defined by the appended claims.

What is claimed is:

1. A motor having a motor portion and a speed-reducing portion comprising:
a gear housing disposed on the motor portion;
a bearing press-fitted in the gear housing;
a worm shaft rotatably held in the bearing;
a worm wheel rotatably held in the gear housing with engagement to the worm shaft;
wherein the gear housing has a bearing hole for accommodating the bearing,
an inner circumference of the bearing hole includes a contact portion for press-fittingly holding the bearing,
a dimension of the contact portion in a circumferential direction of the inner circumference of the bearing hole is determined at a circumferential position of the contact portion, and
at least one contact portion is positioned in an opposite side to a worm wheel engagement side of the worm shaft.

2. The motor according to claim 1,
wherein the bearing is made of an oil-impregnated material.

3. The motor according to claim 1,
wherein the inner circumference of the bearing hole includes a plurality of the contact portions.

4. The motor according to claim 3,
wherein the contact portions are categorized into a small contact portion and a large contact portion based on a circumferential dimension, and
the large contact portion substantially covers half of an outer circumference of the bearing.

5. The motor according to claim 4,
wherein the small contact portion has a tangent line on a circle that has a diameter smaller than a diameter of the outer circumference of the bearing in a view taken from an axial direction of the worm shaft.

6. The motor according to claim 5,
wherein the small contact portions are symmetrically positioned relative to a line of engagement between the worm shaft and the worm wheel in a view taken from the axial direction of the worm shaft.

7. The motor according to claim 5,
wherein the small contact portions are positioned substantially equidistantly on the inner circumference of the bearing hole in a circumferential direction.

8. The motor according to claim 5,
wherein the small contact portions are positioned substantially equiangularly at every 45 degrees of a center angle on the inner circumference of the bearing hole.

9. The motor according to claim 1,
wherein a pair of bearings hold both ends of the worm shaft.
